(19) United States
(12) Patent Application Publication
(10) Pub. No.: US 2008/0285847 A1
(43) Pub. Date: Nov. 20, 2008

(54) Dynamo color coding system to validate, authenticate goods and services

(76) Inventors: Davender K. Panwar, Hamden, CT (US); Jonathan A. Moyer, Killingworth, CT (US)

Correspondence Address: Davender Panwar, 102 Pembroke Road, Hamden, CT, 06514, US

(21) Appl. No.: 11/803,677

(22) Filed: May 15, 2007

(51) Int. Cl. G06K 9/00

(52) U.S. Cl. 382/165

(57) ABSTRACT

Dynamo Color Coding System (DCCS) is a dynamic real time database and color-coding system that has uniquely been combined into a single web based application. The purpose of the DCCS is to give Producers an efficient mechanism to track, validate and authenticate their goods and services as they travel through the supply chain. The attributes for the data to be coded are defined real time and are virtually unlimited. Once the attributes are defined the data is entered using alphanumeric, characters or images into the system and processed through the encoder. The encoder is uses MDCT and Vector Quantization technology, along with the Mobis function. While the data is being processed through the encoder a time stamp and reference number is embedded into the code for authentication. Once encoded a label is created with the color code, the vector of the code and the color space vector. The application can create the code in many shapes that include honeycomb, squares, circles, PDF417 Barcode. The decoding process requires a secure log in and has 3 levels of validation 1) color plus interleave, 2) space decoding and 3) background and foreground color match. The device used for decoding includes RF Reader, digital camera, scanner or any other digital reading device. In addition, the code can be encapsulated into RFID chips, I Buttons or any other device. The verification is done through reading the code with a device and logging into the secure web site. The system conducts a match between the image that was read and the image stored in the database. The data and code are stored in a centralized repository. Dynamo Color Coding System is easy to incorporate into the existing manufacturing and supply chain pipeline and is easy to decode using any digital input device capable of capturing a digital image of the DCCS pattern. This easy to read mechanism will provide a budget alternate to expensive Bar Code scanners and readers, although they will continue to operate by upgrading their software with DCCS based decoders. It is also compatible to verity of printers from laser, inkjet, expensive label printers etc. due to generic in nature its inclusion in the goods and services pipeline will not only reduce the cost but will provide an auditable tracking mechanism.

### CROSS-REFERENCE TO RELATED APPLICATION

Application Number: 6818, Confirmation Number: 154 EFS ID: 11857

### STATEMENT REGARDING FEDERALLY SPONSORED RESEARCH OR DEVELOPMENT

Not applicable.

### FIELD OF THE INVENTION

The present invention relates to providing Producers of Goods and Services the ability to electronically validate, authenticate and track their goods and services through the service and supply chain with an audit trail. This is accomplished by incorporating product specific attributes into a web managed and controlled centralized database repository combined with unique color gamut or black and white spectrum space code. This Space Code has a pentagram as a base layer to stop copy of the same, a hot or cold stamped hologram to avoid its removal from a product being used at a high temperature. The product or service attributes are created real time and tied to the Dynamo Color Code (DCC) generator (part of DCCS code) to generate personalized product and service identification and labeling in real time and is highly specific to that product or service.

### BACKGROUND OF THE INVENTION

It can be appreciated that goods and service labeling has been used for tracking purposes for many years. However in recent years due to heightened security, the increase of non-original product, the health and safety of society and the increase in global competition, the needs of Producers have changed. Producers need the capability of ensuring their original goods can be monitored, effectively tracked and can validate their service or process. Examples would include, patient tracking at a hospital or authenticating a legal document. Also, effectively and efficiently isolate and recall a product from the market that is defective or a health hazard.

The main problem for Producers of goods and services is they do not have any mechanism to incorporate secure or non secure methods to validate, authenticate and track their goods and services that includes an audit trail with an application that links the database to the code generator on a real time basis providing maximum flexibility.

The primary alternatives available to Producers are a label, barcode, paper trail mechanism, pickup slips, invoices etc. However, neither of these alternatives produces a solution and is mainly used to track movement versus validation and authentication.

Standard information labels are not an effective alternative as they are used to merely convey information about the goods and services and don't ensure validation and authentication. Barcode is used to identify a product type and is useful at the point of sale but does not have the capability to validate and authenticate a good or service. It is difficult to differentiate a counterfeit from a genuine product.

1D Barcodes form the backbone of 21st century distribution sales and inventory management. UPC code detection works on a scanner that scans the straight lines separated by white space. However, the code is limited to one identifier as its existence hinges on a part, item or service number.

2D barcodes try to provide, by encapsulating product price and some additional details but it lacks a supportive backend database to provide any validation or authentication.

Although printers and scanner resolution to print and read has improved drastically do to hardware enhancements, relying completely on a printed label or code can cause misinterpretation of labeled information due to error in printing, loss of color or pixel. DCCS addresses this issue with a unique process in which the label will include critical information in multiple sets and serious loss will be compensated by accessing lost information in the central repository. It also provides the ability to access additional information through a backend database. The database will contain product specific attributes.

A Major issue with the current alternatives is they can not address the following problems, which are serious in nature and cannot provide relief for enclosed problems of any kind:
Verification of Goods and Services being purchased are original.
No Parent or third party verification.
No Parent or third party validation.
No government or corporate efficient tracking mechanism to perform any kind of Audit trails.
There is no way a common consumer can differentiate an original from a non-original product.
Non-original goods and services product identification is so good that even experts have problem in separating them from the original.
Effectively track and validate a service
Data for the code has to be preloaded into the primary database and selected as a variable and then converted into a code, it is not dynamic. Anyone can copy the code generated data to create real labels.

The Dynamo Color Coding System (DCCS) was created to meet the need for an economical and an efficient system, that will allow a Producer to effectively monitor and track their goods and services through the service and supply chain to ensure their original product reaches the consumer and that Service providers can ensure the process and procedures are meeting standards. Also, by means of web based access and printing the Producer can reduce implementation costs and have a secure data repository restricting unauthorized access. Some of the salient features of DCC are:
Easy to implement.
Link between the dynamic database and the code generator
The DCC is converted into a image blob and stored in the database
Will generate a dynamic Time Stamp controlled DCC pattern.
Flexible number of Producer defined parameters.
Color coded background and pattern color code
Specialized Database Schema.
Personalized Profile Engine
Custom Search Engine to perform dynamic and index searches.
Complex Pattern generating Algorithm.
GUI (Graphical User Interface), which validates and verifies the purchased goods and services by a customer.
Due to Dynamic nature of the DCC Pattern and its variation from batch to batch there will be more effective product tracking and monitoring through the supply chain.
The verification of DCC is performed via secure servers with appended information from each user within the supply chain pipeline creating an elaborate Audit Trail.
The Audit trail strengthens the ability to track, monitor, validate and authenticate goods and services.
A pentagram as base layer will deter copiers.
A hot or cold stamped hologram will avoid its removal from a product to help warranties and tracking.
DCCS will help organizations meet compliance and audit requirements as defined by HIPAA, Sarbanes Oxley and other regulatory requirements.

In these respects, the DCC system according to the present invention substantially departs from the conventional concepts of design and prior art, and in so doing provides an apparatus primarily developed for the purpose of verification, validation and tracking of goods and services.

### SUMMARY OF THE INVENTION

In the view of the forgoing disadvantages inherent in the known types of validation, authentication or audit trail providing system present in the prior art, the present invention provides a new innovative encrypted easy to incorporate and secure system construction using DCC & Database Schema whereas the same can be utilized for audit trails and also to verify and validate authenticate purchased goods and services.

The general purpose of the present invention, which will be described subsequently in greater detail, is to provide a new authentication, validation and audit trail system that has many of the advantages of having a true goods and service mentioned heretofore and many novel features that result in a new secure system which is not anticipated, rendered obvious, or even implied by any of the prior art label, either alone or in any combination thereof.

To attain this, the present invention comprises a DCC generated pattern. DCCS will provide an urgently needed service by providing authentication, verification and an audit trail to Producers of goods and services.

There had thus been outlined, rather broadly, the more important features of the invention in order that the detailed description thereof may be better understood, and in order that the present contribution to this art may be better appreciated. There are additional features of the invention that will be described hereinafter.

In this respect, before explaining at least one embodiment of the invention in detail, it is to be understood that the invention in not limited on its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

A primary object of the present invention is to provide Producers and Customers a system to authenticate, verify and audit purchased goods and services that will overcome the shortcomings of the prior art devices, if any in use or exist.

An object of the present invention is to provide customers a system to authenticate, verify and audit purchased goods and services at point of sale.

An object of the present invention is to provide customers a system to authenticate, verify and audit purchased goods and services from their personal computers.

An object of the present invention is to provide producers a system to authenticate, verify and audit sold goods and services at point of sale.

An object of the present invention is to provide producers a system to pinpoint location of their goods and services in the supply chain pipeline.

An object of the present invention is to provide producers a system to generate in real time sale and movement of goods and services provided by them.

An object of the present invention is to provide producers a system to monitor and track their original products in the supply chain pipeline.

An object of the present invention is to provide producers a system to define their personalized attribute list to generate a complex color coded pattern using the DCC and they can change these attributes confidentially thus adding an extra factor of security.

An object of the present invention is to provide producers a system complete with a database schema to capture all movement of their goods and services with a detailed audit trail. There is no need to any additional software to mine the sales data, as it is always available to them as it is part and parcel of DCC system.

An object of the present invention is to provide producers a system that does not interfere with their pricing system that is barcode.

An object of the present invention is to provide producers a system of additional security as it encrypts information and details required to explain their goods and service with no predefined length or other requirements. Encrypted information always relate to the backend database schema thus enhancing the security of supply chain pipeline.

An Object of the current invention is to provide producers and government the ability to authenticate and validate security access badges or methods.

An Object of current invention is to provide companies in the service industry and the government the ability to validate and authenticate critical documents.

Other objects and advantages of the present invention will become obvious to the reader and it is intended that these objects and advantages be within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

FIG. 1. Illustrates the database/Dynamo Color Code generator process

FIG. 2. Illustrates the DCCS database process summary. The key element of the process is that the DCC uses XML technology that allows the data to be ported into existing Customer systems.

FIG. 3. Illustrates the data input phase of the process.

FIG. 4. Illustrates the process flow of the encoder (Pattern Generator). This starts with the input phase by the user then as the DCC is generated a time stamp is added and the code is then generated.

FIG. 5. Illustrates a PDF417 code generated by DCC and includes the data input. The code includes the data and timestamp.

FIG. 6. Illustrates the different ways the DCCS generated code can be represented.

FIG. 7. Illustrates a summary of the Reading and Decoding Process

FIG. 8 Illustrates examples of the Decoding process.

FIG. 9. Illustrates additional examples of the Decoding process

FIG. 10. Illustrates and example of the Verification (Validation and Authentication) process.

FIG. 11. Illustrates the secure process flow summary. This shows a sample of the secure process flow based on a business process perspective

### DETAILED DESCRIPTION OF EMBODIMENTS

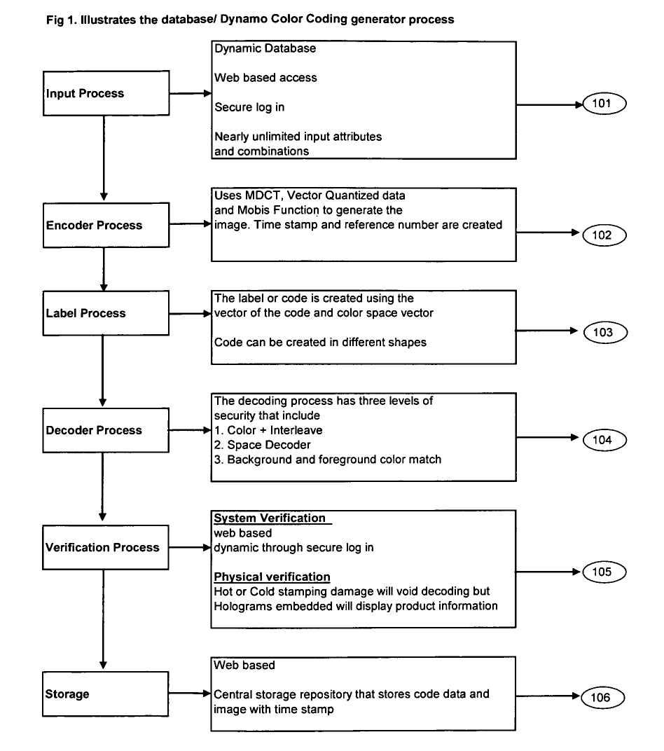

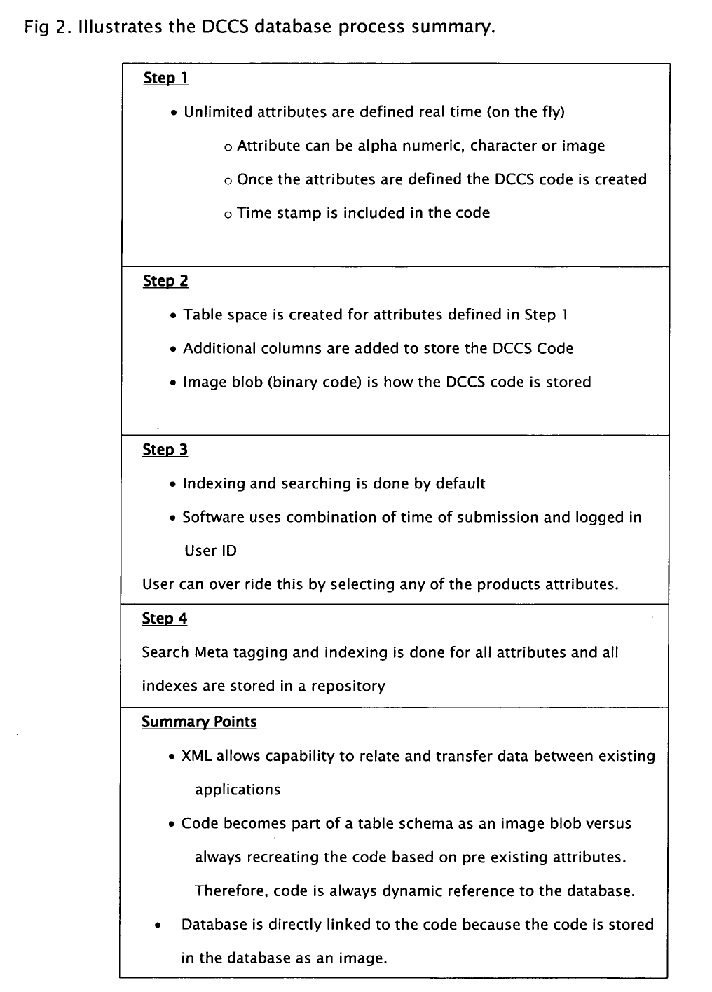

FIG. 1. Illustration of the database/DCC generator process flow 101 shows characteristics of the input process that is based on the dynamic real time database that is linked to the code generator. This is web based and requires a secure log in. During this process the User identifies the attributes that require DCCS, and then input the actual data. 102 shows the encoder process that takes the data and uses a unique algorithm that consists of MDCT, Vector Quantization and the Mobis function. The data is taken from 101 and is processed through the encoder. This where the time stamp and reference number are added. 103 Shows the labeling process or the actual process that creates the DCC, this includes the Vector of the code and color space vector. The benefit of the application is that a label/code can be generated in multiple shapes included but not limited to squares, honeycombs, lines, bars. 104 Shows the decoding process that includes three levels of security through validation and authentication. These include color and interleave, space decoder and background color match. 105 Shows the verification (validation and authentication) process that includes using the web-based database with a secure user log in. The user reads the DCC using various devices and the image is matched against the original image stored in the database. Additionally, using a hot or cold stamped hologram will avoid its removal from a product and still allow for verification 106 Shows the storage process that is web based and has a central database repository. The data being stored includes the user-defined attributes, the inputs and an image blob of the DCC.

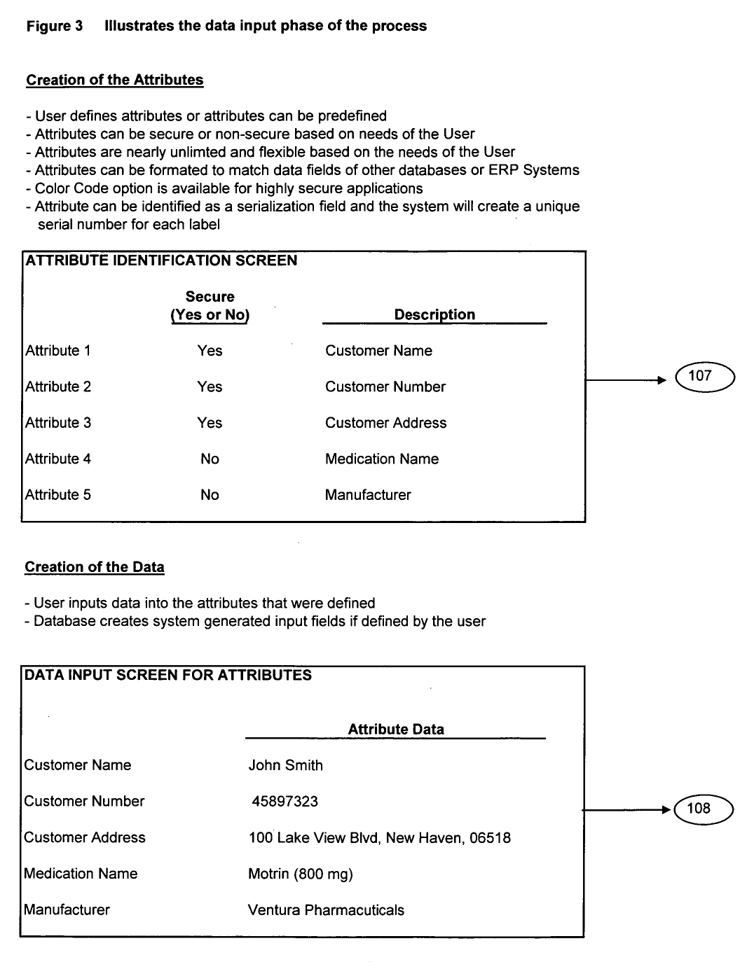

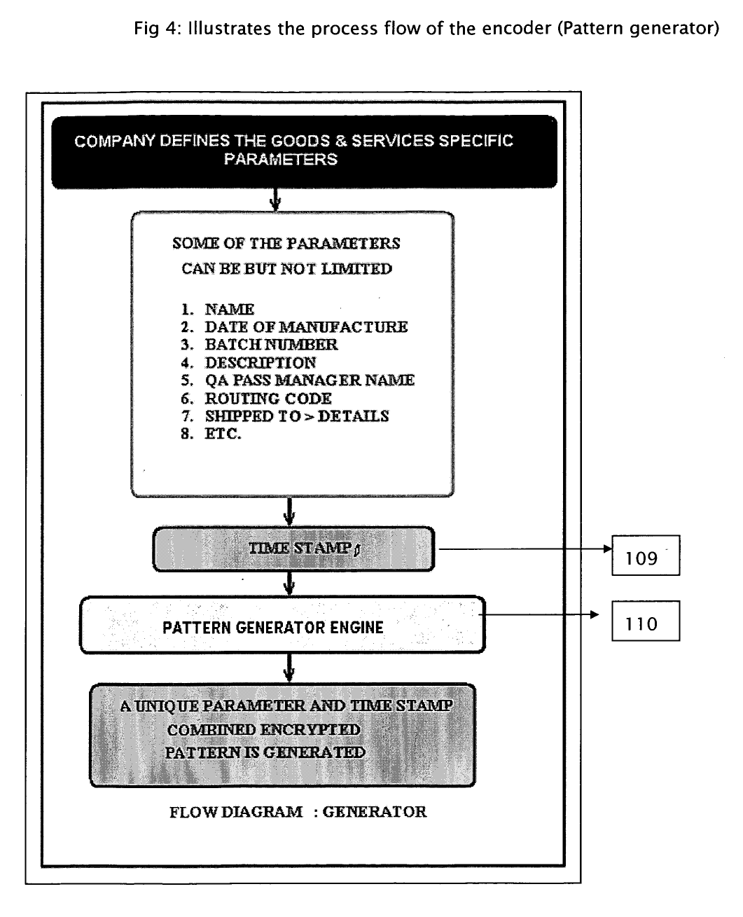

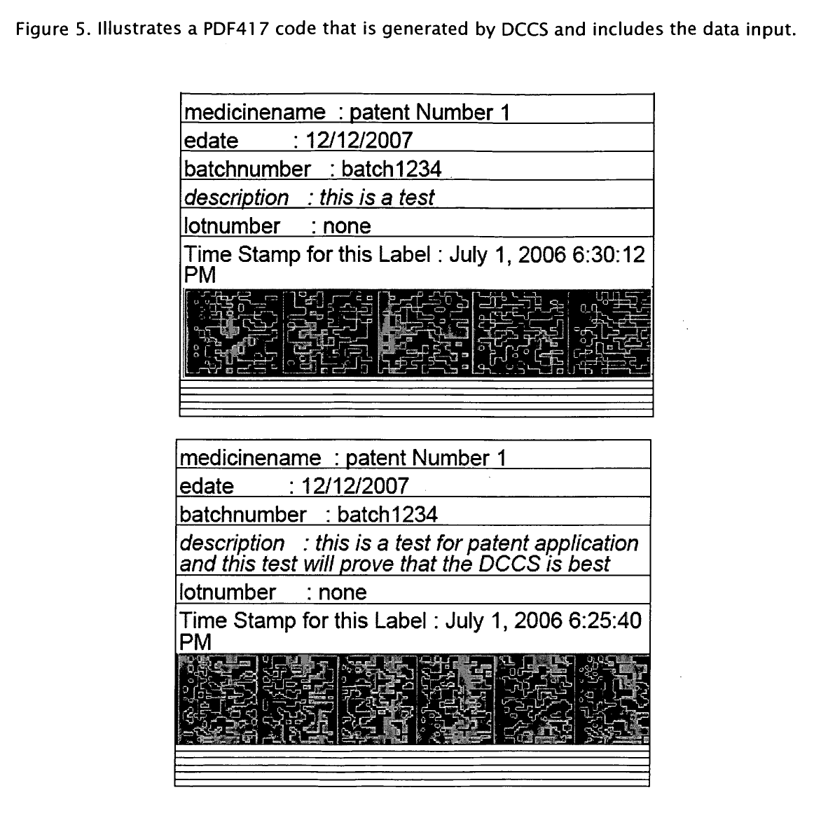

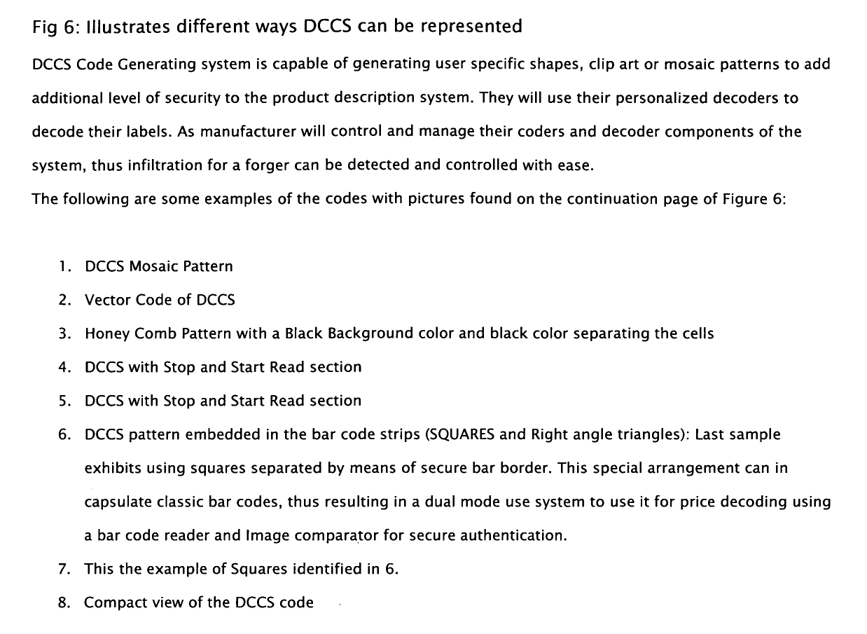

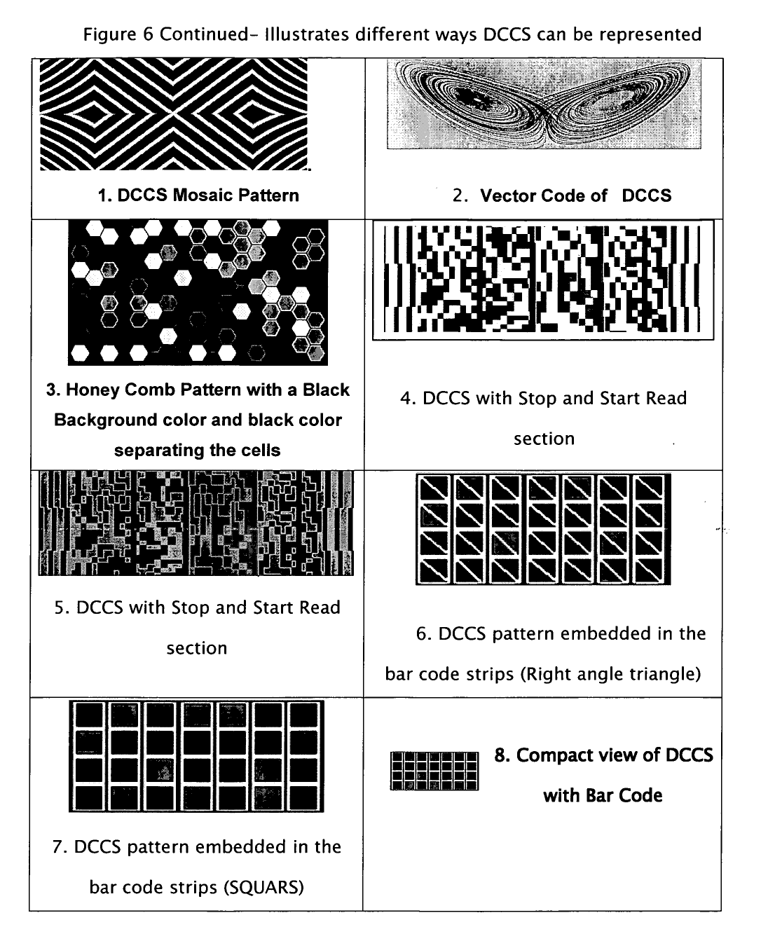

FIG. 3. Illustrates the data input phase of the process. 107 Shows a sample input screen for the user to identify attributes that are to be encapsulated into the DCC. 108 Shows the sample input screen for the user to input the actual data for the attributes that were defined in 107.

FIG. 4. Illustrates the process flow of the encoder (pattern generator). 109 Shows where in the process the time stamp is created. 110 Shows the pattern generator where the reference number is generated for the DCC.

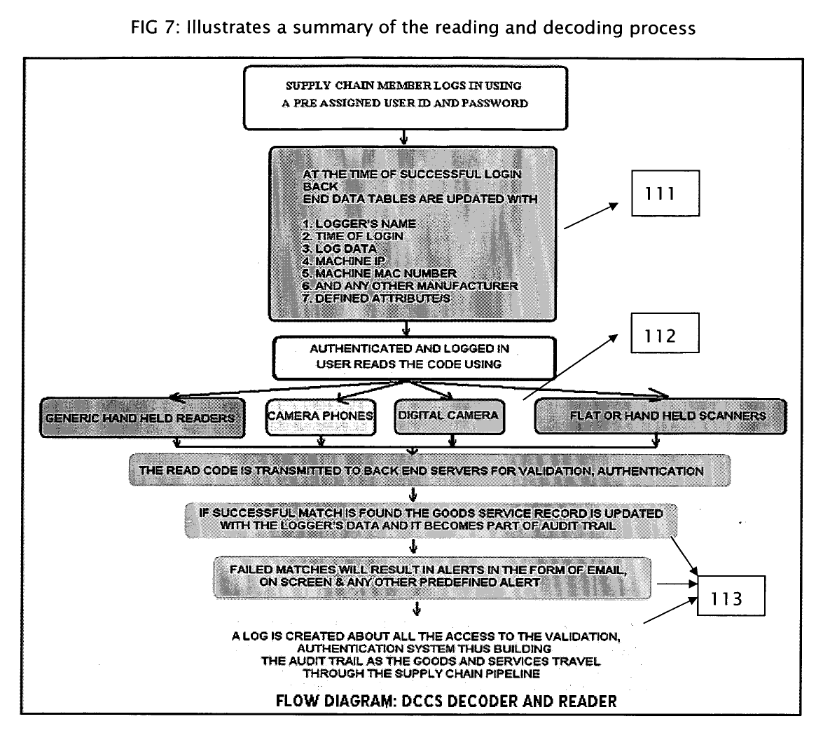

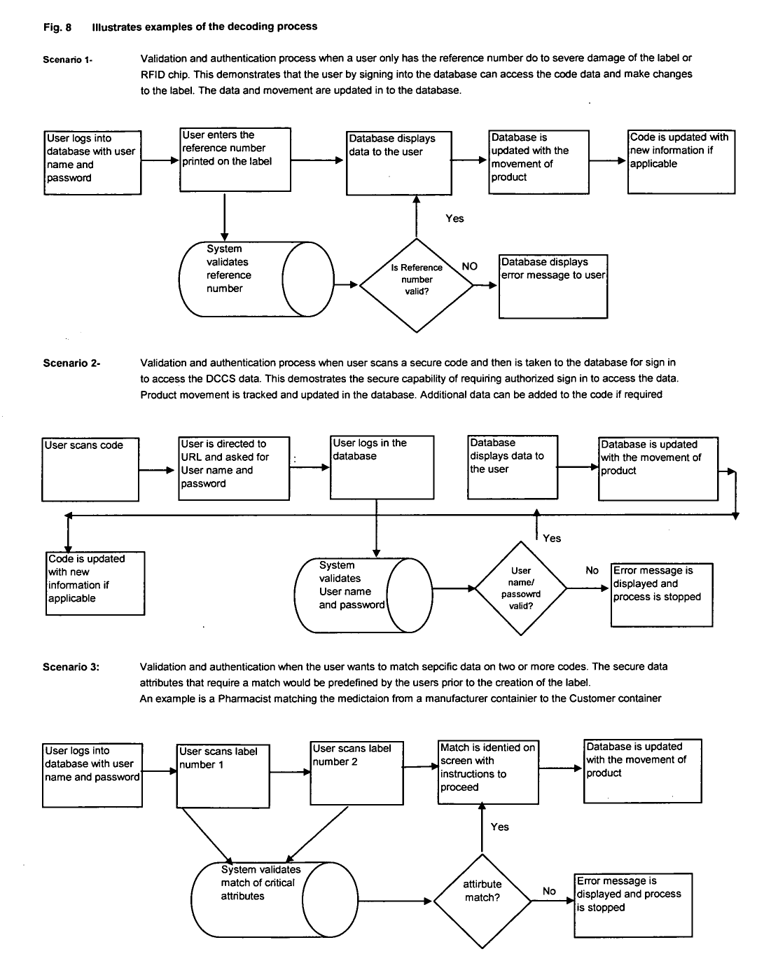

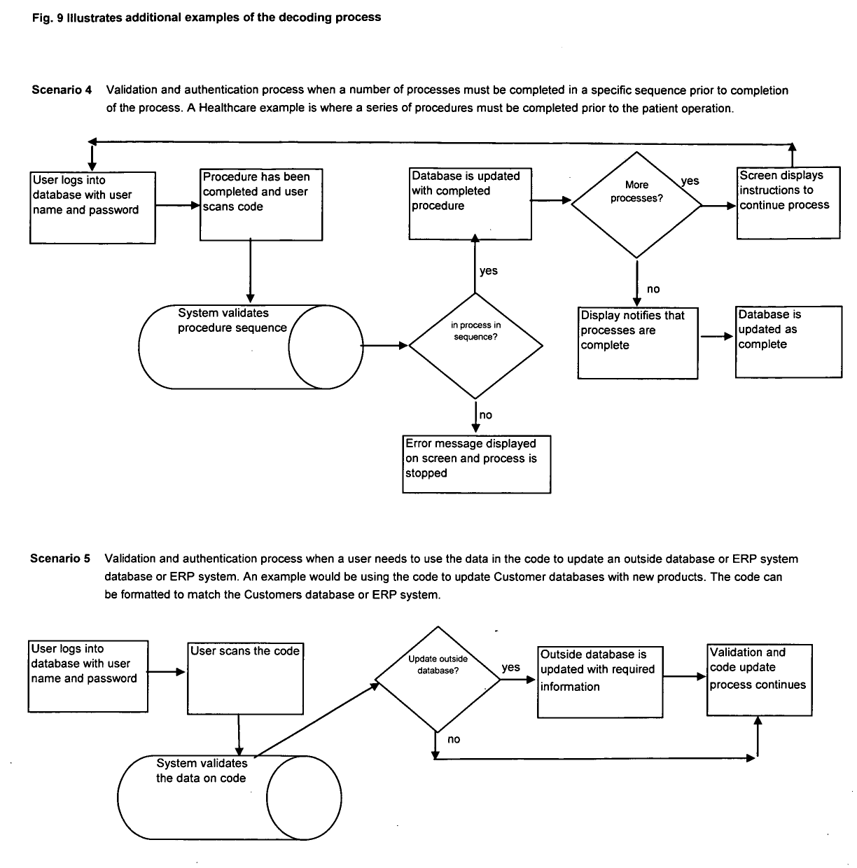

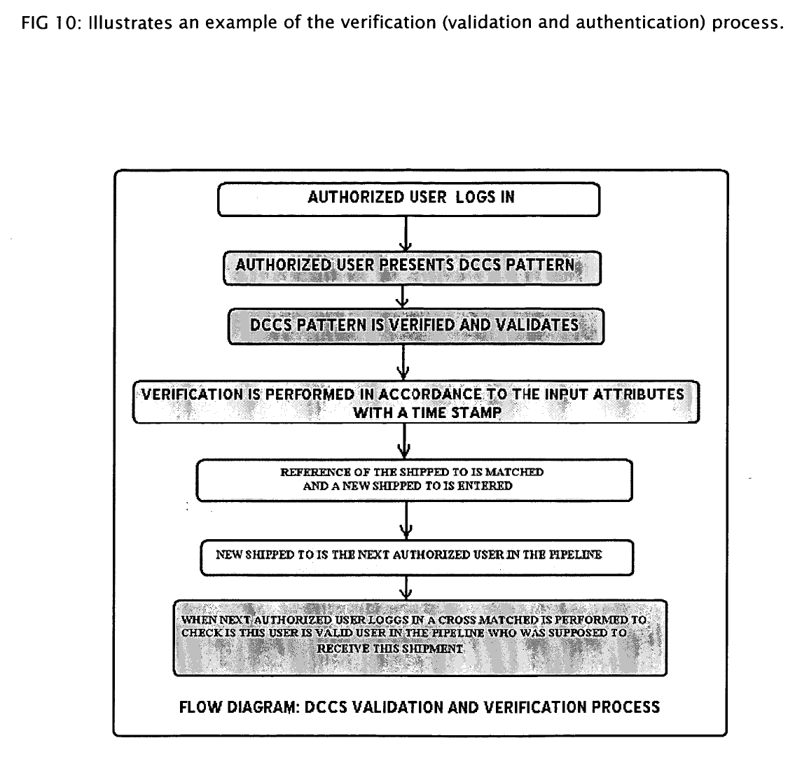

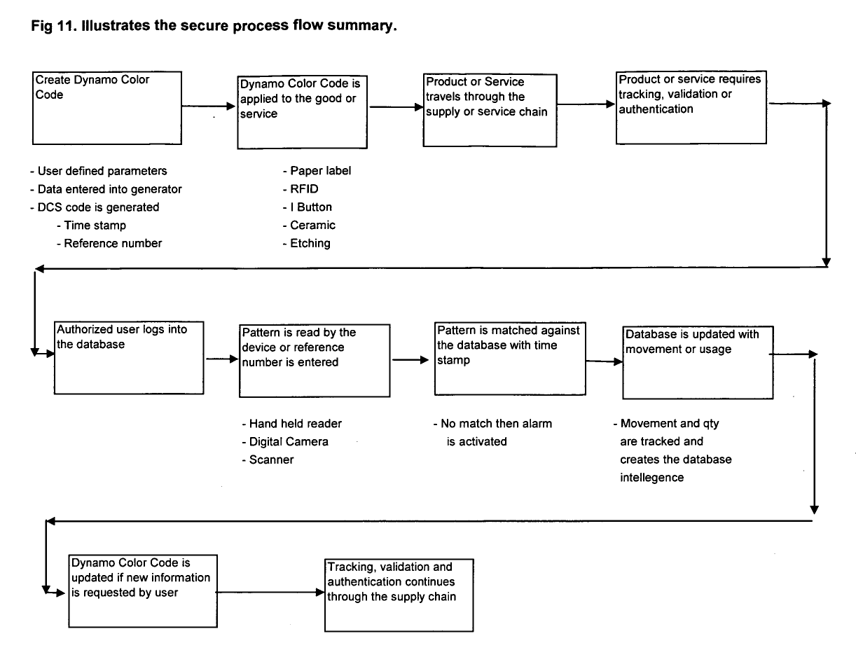

FIG. 7. Illustrates a summary of the Reading and Decoding Process. 111 Shows that the user logs into the system and the database is updated with the user information to track user access to the data. 112 Once the user is logged in they will use the various devices identified in the figure to read the DCC. 113 The DCC is then decoded and the database update processes is shown.

What is claimed is:

1. The DCC is a dynamic database and code generator that operates real time

2. With reference to claim 1, a database that enables users to identify attributes on a real time basis

3. With reference to claim 1, a database that enables users to enter data on a real time basis and is directly linked to the code generator.

4. With reference to claim 1 a database that stores the data and the DCC in the same centralized repository by converting the DCC into an image blob.

5. The Dynamo Color Code System (DCCS) will consist of a Dynamo Color Code generator, database schema, digital image processing, RF readers, memory chips and coders. The Dynamo Color Code System (DCCS) will consist of a black and white generator for budget printing.

6. The Dynamo Color Code System (DCCS) will enable a Producer or Distributor of goods and services to enter data based on attributes that are defined real time or predefined text fields that is processed through an algorithm and will create a unique code (pattern) that includes a color option.

7. The DCCS comprises the ability to condense data elements into a code (pattern) and is a normalized database instead of a distributed or scattered database.

8. The DCCS color option comprises the ability to create a unique background color, or use a pentagram or a hologram and pattern color based on each code generated that will be used in the validation/authentication process.

9. The DCCS will consist of a time stamp that will identify when the code was generated

10. The DCCS database schema will consist of an audit trail that will identify the path and location of a good or service.

11. The DCCS color pattern forms one layer of coded data and interleaved space from a second layer of data for enhanced security during the authentication phase.

12. The DCCS validation/authentication process will consist of a comparison of the original data that was entered into the code generator against the actual instrument that contains the code (pattern).

13. The DCC will be added to an instrument (paper label, plastic, memory chip, ibutton, flash drive, bodies of manufactured goods as hot or cold stamping) that will be applied to the good or service.

14. This DCCS has a pentagram as base layer to stop copy of the same

15. DCCS can be applied as hot or cold stamped hologram to avoid its removal from a product being used at a high or cold temperature.

16. The DCCS will also consist of a unique 9 digit number that will relate to the code (pattern) that is generated and will allow to user to enter that number into the database schema in the invent the instrument that contains the code is damaged.

17. The DCCS code (pattern) matching will be accomplished through image processing technology that includes digital image devices, data scanners, RF Readers, memory sticks and CD-ROMS.

18. The DCCS backend schema will treat data coming from different sources that is vehicle information, passenger manifestos, train/bus pass, event e-tickets, pathological samples, hospital records management.

19. DCCS will assist organizations meet regulatory compliance requirements such as but not limited to Sarbanes Oxley and HIPAA requirements.

20. Background color management will control and eliminate counterfeit codes Foreground color management will eliminate codes at detection level.
